(19) United States
(12) Patent Application Publication
(10) Pub. No.: US 2012/0144331 A1
(43) Pub. Date: Jun. 7, 2012

(54) Method for Arranging Application Windows on a Display

(76) Inventors: Ari Tolonen, Honkola (FI); Panu Johansson, Tampere (FI); Pekka Ketola, Tampere (FI); Lotta Partanen, Helsinki (FI); Jari Selenius, Nurmijarvi (FI)

(21) Appl. No.: 12/960,138

(22) Filed: Dec. 3, 2010

(51) Int. Cl. G06F 3/048

(52) U.S. Cl. 715/769; 715/800; 715/799

(57) ABSTRACT

A data processing device is controlled to display a first application on a display area. A size of a displayed first application area is determined. In response to determining that the size of the display area is larger than the displayed first application area, the data processing device is controlled to display a task switching area on the remaining part of the display area.

### TECHNICAL FIELD

The present invention relates to user interfaces, and more particularly to a method, an apparatus and a computer program for arranging application windows on a display.

### BACKGROUND

Contemporary mobile devices support a multiplicity of functions, which are typically used via application windows shown on a display of the device. At the same time, it has become more complicated to design a user interface that enables the user to access the plurality of functions and applications via their application windows. Especially, multitasking between the plurality of applications is becoming more advanced and widespread, but it is challenging to implement multitasking on a small-sized display.

Accordingly, there is a need for simplifying the manner in which multitasking between application windows is carried out and enhancing functionality of multitasking, for example, in touch screen user interfaces.

### SUMMARY

Various aspects of the invention include a method, an apparatus and a computer program, which are characterized by what is stated in the independent claims. Various example embodiments of the invention are disclosed in the dependent claims.

According to one aspect, a method according to the invention is based on the idea of controlling a data processing device to display a first application window on a display area; determining a size of a displayed first application area; and controlling, in response to determining that the size of the display area is larger than the displayed first application area, data processing device to display a task switching area on the remaining part of the display area.

According to an example embodiment, said task switching area provides one or more user interface elements for accessing other applications or application windows of the data processing device.

According to an example embodiment, the method further comprises activating said first application area to be displayed on a majority part of the display according to a native resolution and aspect ratio of the first application area; and controlling, in response to detecting that the native resolution and aspect ratio of the first application area is smaller than the size of the display of the data processing device, the data processing device to open the task switching area to be displayed on the remaining part of the display area.

According to an example embodiment, the method further comprises activating said first application area to be displayed on the part of the display according to a user command; and controlling, in response to detecting that the first application area is arranged to be displayed on a display size smaller than the size of the display of the data processing device, the data processing device to open the task switching area to be displayed on the remaining part of the display area.

According to an example embodiment, the method further comprises detecting a user command for opening a second application area, said user command being provided via a user interface element in said task switching area; in response to opening said second application area, rearranging the application areas on a display such that the second application area is displayed on a majority part of the display; and at least the first application area is displayed on the part of the display area available for applications not covered by the second application area.

According to an example embodiment, the method further comprises detecting a user command for activating the first application area displayed on the part of the display area available for applications not covered by the second application area; and rearranging at least the first and the second application areas by moving a boundary between adjacent borders of the second application area and the first application area along a horizontal or a vertical axis of the display such that the first application area is displayed on a majority part of the display.

According to an example embodiment, the method further comprises detecting a user command for activating the first application area displayed on the part of the display area available for applications not covered by the second application area; and rearranging at least the first and the second application areas by arranging the first application area in a desired location on the display and arranging at least the second application area to be displayed on a leftover region of the display.

According to an example embodiment, the method further comprises detecting a first user command for selecting a data item of the first application area to be copied to the second application area; dragging, in response to detecting a second user command, the selected data item to said second application area; copying, in response to detecting a third user command, said data item to said second application area; and activating said second application area to be displayed on a majority part of the display according to a native resolution and aspect ratio of the first application area.

According to an example embodiment, the method further comprises controlling, in response to activating the first application area on said part of the display, at least two application areas to be displayed on the remaining part of the display area available for application areas.

According to an example embodiment, the first and the second application areas are application windows of different applications, or the first and the second application areas are two different application windows of a particular application.

According to an example embodiment, said display is a touch screen display and the activation is carried out by touching the application area in question or the user interface element representing said application area or underlying application in said task switching area.

According to an example embodiment, the method further comprises modifying at least a second application area to be displayed on the remaining part of the display such that the size of the at least second application area is at least a predetermined minimum size enabling effortless touching of the at least second application area.

According to another aspect, there is provided an apparatus comprising at least one processor and at least one memory storing computer program code, the at least one memory and the computer program code being configured to, with the at least one processor, to cause the apparatus to at least control a first application to be displayed on a display area; determine a size of a displayed first application area; and control, in response to determining that the size of the display area is larger than the displayed first application area, the apparatus to display a task switching area on the remaining part of the display area.

According to a further aspect, there is provided a computer-readable storage medium comprising computer program code, which computer program code, when executed in at least one processor, is configured to cause an apparatus to at least control a first application window to be opened on a display; activate the first application to be displayed on a display area; determine a size of a displayed first application area; and control, in response to determining that the size of the display area is larger than the displayed first application area, the apparatus to display a task switching area on the remaining part of the display area.

### LIST OF DRAWINGS

In the following, various example embodiments of the invention will be described in more detail with reference to the appended drawings, in which

FIG. 1 is a schematic diagram of an apparatus;

FIG. 2 shows a flow diagram of a method;

FIG. 3 shows a display view created according to the above method;

FIG. 4 shows a flow diagram of a method according to an embodiment;

FIGS. 5a and 5b show display views created according to the above method;

FIGS. 6a, 6b, and 6c show display views for applications in vertical position;

FIG. 7 shows a flow diagram of a method according to an embodiment; and

FIGS. 8a, 8b, 8c, and 8d illustrate, by means of examples of display views, the performance of the above method.

### DESCRIPTION

In the following, several example embodiments of the invention will be described in the context of a touch user interface and methods and devices for the same. While the benefits of the embodiments are apparent when implemented in small-size touch user interfaces of portable devices, it is to be noted that the invention is not limited to touch user interface only. In fact, the different embodiments have applications widely in any environment where improvements of user interface operations are required, even in conventional large computer displays.

Further examples of devices, which may benefit from the use of the invention, include devices with a large touch screen such as e-books and digital newspapers or personal computers and multimedia devices such as tablets and tables. Likewise, user interface systems such as interfaces of various navigators may benefit from the invention.

FIG. 1 illustrates a schematic diagram of an apparatus 100. The apparatus 100 may, for example, be a portable data processing device, such as a mobile phone or a PDA (Personal Digital Assistant) device. The apparatus 100 comprises processing circuitry 102, a storage device 104, and a user interface 106 comprising a user input device 108 and a user output device 110. If implemented as a mobile phone, the apparatus further comprises a radio transceiver.

The processing circuitry 102, or generally a processor, may comprise but is not limited to one or more microprocessors, one or more processor(s) with or without accompanying digital signal processor(s), one or more special-purpose computer chips, one or more field-programmable gate arrays (FPGAs), one or more controllers, one or more application-specific integrated circuits (ASICs), or one or more computer(s).

The processing circuitry 102 is connected to the storage device 104, or generally a memory, thus enabling to write to and read from the storage device 104. The storage device 104 may comprise one or more memory units, such as a RAM, a ROM, a CD-ROM, etc. The storage device 104 may store computer program instructions 112 that control the operation of the apparatus 100 when executed in the processing circuitry 102.

The computer program instructions 112 may be loaded into the storage device 104 of the apparatus 100 via an electromagnetic carrier signal through a network, for instance using a TCP/IP protocol stack or be copied from a physical entity, such as a memory device, a record medium such as a CD-ROM or DVD, or a hard disk of a PC.

The processing circuitry 102 is connected to the user interface 106, thus enabling to receive an input from the user input device 108 and to provide an output to the user output device 110. The user input device may comprise a keypad, a pointing means, such as a mouse, and/or a touch screen. The user output device 110 typically comprises a display device. The user input device 108 and the user output device 110 may be combined into a single user interface unit, such as a touch screen display device, enabling a user to provide an input to the touch screen display device using, for example, a finger or a stylus.

For the sake of illustration, the following embodiments and examples are described in connection with a touch screen display device to be used as the user interface. Many touch screen technologies are known, including technologies based on resistive, inductive and impactive techniques. In general, different kinds of taps applied to a touch screen can be detected for activating different types of modes, functions, and behaviours. The touch screen may be configured to detect a location and duration of user touches or taps, and modify behaviour of application window functionality based on tap location and duration. The touch screen may also be configured to detect a delay between taps of the same type and/or differing type, and modify behaviour of application window functionality based on detection of a tap within or beyond a delay period. The touch screen may also be configured to respond to movement at a point of a tap. The touch screen may also be configured to receive touch inputs in multiple locations at the same time. For example, a user can press the screen with two fingers, simultaneously, and both presses are detected and used as part of the input.

However, it will be apparent for the person skilled in the art that in various embodiments described below, the user input device 108 and/or the user output device 110 need not be a touch screen display device. The embodiments are equally applicable in an environment, wherein the user input device 108 is, for example, a keypad and/or a mouse and the user output device 110 is a display device without a touch input feature.

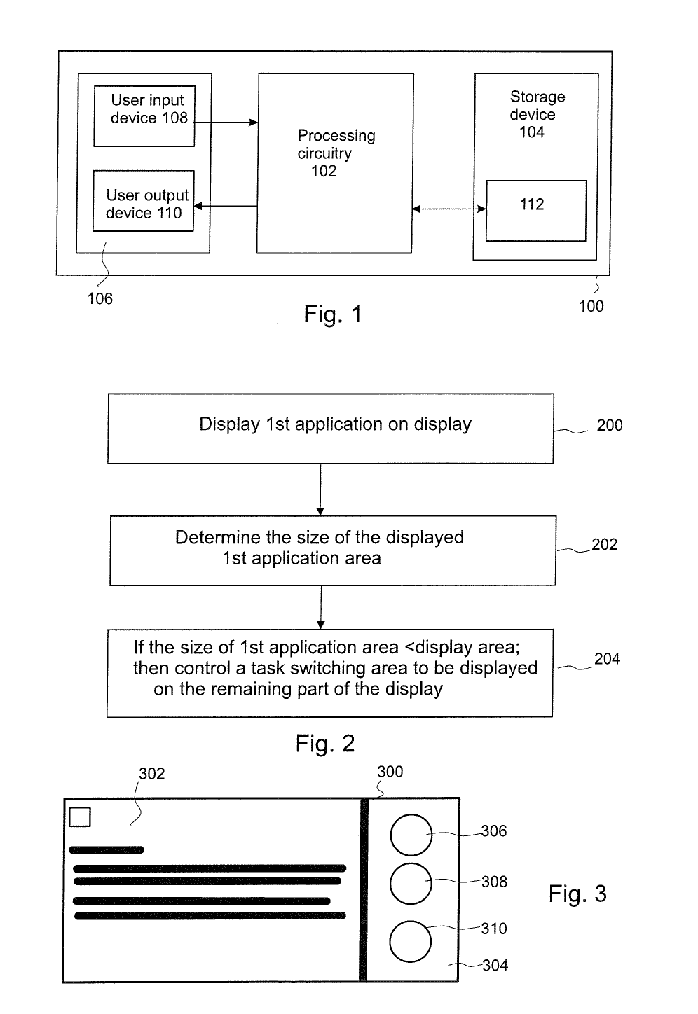

FIG. 2 illustrates a flow diagram of a method, wherein the blocks 200, 202 and 204 illustrated may represent steps in a method and/or sections of code in the computer program 112. The illustration of a particular order of the blocks in this and further flow diagrams below does not necessarily imply that the method steps and/or the sections of code are implemented in this particular order, but the order and arrangement of the blocks may be varied.

The procedure described in the following, e.g. bringing automatically a task switching area, which may also be referred to as “a sidebar application” or “a task switcher”, to the display provided that there is unused display area, may be a default operation of the data processing device, whereby the device arranges the application windows on the display as described below. It is possible that the procedure may be activated and deactivated by a user setting. Since the procedure can be implemented as a computer program, it is also possible that the computer program is loaded afterwards in the data processing device, e.g. as a plug-in. The operation may also be a part of the user interface module of the operating system of the device. All the above options apply to the various embodiments relating to displaying at least two application windows, which are described further below.

At block 200, a data processing device, e.g. similar to the apparatus referred above, is controlled to display a first application on a display area. In practise, this may be carried out such that the data processing device opens an application and displays the application in a first application window, i.e. in a first application area. The first and possible further application areas, such as application windows, may be opened in response to one or more user commands or the opening of the application windows may be a part of an automated process, e.g. a start-up sequence of an application.

The term “display area” as used herein refers to the part of the display surface, which is available for applications to be displayed at a given moment. It is to be noted that the display area available for applications may not necessarily cover the whole area of the display surface, but there may exist, for example, one or more toolbars or icons, which as a default setting are always shown on the display, and only the area of the display surface beyond these toolbars or icons is available for application areas. Thus, the “display area” may be device-specific, i.e. dependent on the implementation and settings of the device and its display. Likewise, the “display area” may be application-specific, i.e. dependent on the area reserved for other applications, toolbars or icons at a given moment.

The term “application area” as used herein refers to the part of the display surface, which is covered by an instance of the application as displayed. The instance of the application may be, for example, a window of an application executed by the device or a window of a document established by an application.

The term “application window” as used herein refers to a window of a specific application, e.g. a window of an email application, but also to document windows within a specific application, e.g. a plurality of windows opened in a text processing application. It is also possible that opening a window of a first application, e.g. an email application, automatically opens another window in a second application, e.g. in a contacts application. Furthermore, opening a window does not necessarily imply that the actual window is shown on the display, but it may be only included in a list of opened windows or shown as an icon, for example. The list of the opened windows or the icon may be shown on the display, or they may be hidden as well.

Therefore, the term “first application area” does not refer to any particular order, in which the applications are opened, but, for example in case of a plurality of opened applications shown as a list of the opened applications or as icons, rather to any application which is controlled to be displayed, at a given moment, on the display.

At block 202, the size of the displayed first application area is determined. The application establishing the displayed first application area may have, for example, application-specific predetermined settings for the size of application area to be used, or user-defined settings for the size of application area to be used. The displayed first application area may have a size that covers the whole display area, but in this embodiment it is presumed that the size of the displayed first application area is smaller than the available display area.

At block 204, in response to determining that the size of the display area is larger than the displayed first application area, the data processing device is controlled to display a task switching area on the remaining part of the display area. According to an embodiment, the task switching area refers to a user interface section providing one or more user interface elements for accessing other applications or application windows of the data processing device. The user interface elements may, for example, provide access to open tasks, favourite applications and/or clipboard items.

The first application area is displayed on a part of the display, in other words, the first application area does not cover the whole area of the display. According to an embodiment, the first application area is activated to be displayed on a majority part of the display according to a native resolution and aspect ratio of the first application area. For example, if the application is designed for a display with an aspect ratio of 16:9 (width:height), then using such aspect ratio of the first application area on a display having an aspect ratio of 21:9 would cover a majority part of the display, but not the whole display area. The aspect ratio may relate to e.g. video or image content being displayed in the application area.

The native resolution and aspect ratio of the first application area may also be such that they adjust the first application area to be displayed on a minority part of the display.

Nevertheless, in response to detecting that the native resolution and aspect ratio of the first application area is smaller than the size of the display of the data processing device, the data processing device is controlled to open the task switching area to be displayed on the remaining part of the display area available for applications. Consequently, upon noticing that there is unused display area, the data processing device advantageously utilizes this remaining display screen area and opens the task switching area therein.

According to an embodiment, the part of the display area that the first application area covers may be adjustable according to the preferences of the user. For example, depending on the application the user may wish to reserve either a minority or majority part of the display area for a particular application.

Then again, in response to detecting that the first application area is arranged to be displayed on a display size smaller than the size of the display of the data processing device, the data processing device is controlled to open the task switching area to be displayed on the remaining part of the display area available for applications.

FIG. 3 illustrates a display view created according to the above method. In FIG. 3, there is depicted a display 300, for example a small-sized touch screen, having a first application area shown as a first application window 302 activated on the left side of the display 300. The first application window 302 is preferably arranged to cover a majority part of the display according to its native resolution and aspect ratio. Upon having noticed that first application window 302 covers only a part of the area of the display 300, the device controlling the display has arranged a task switching area 304 to cover the remaining part of the available display area on the right side of the display 300. The task switching area 304 comprises user interface elements 306, 308 and 310, which upon activation, e.g. a tap by a finger or a stylus, provide access to other applications or application windows of the data processing device, such as open tasks, favourite applications and/or clipboard items.

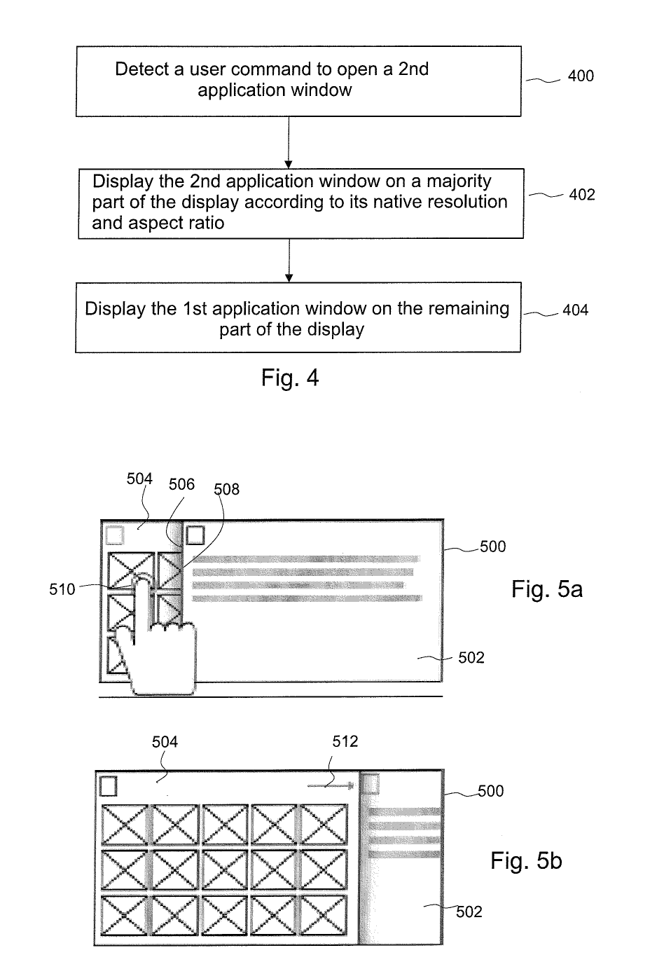

FIG. 4 illustrates a flow diagram of a method according to an embodiment, wherein the display view is rearranged when the user opens a second application window and switches between the application windows. The starting point of the method according to this embodiment is the display view created as described in FIG. 2 and FIG. 3, i.e. the first application window being displayed on a majority part of the display, and the task switching area being modified to cover the remaining part of the available display area.

At block 400, a user command for opening a second application window is detected in the data processing device. The user command for opening said second application window is provided via a user interface element in said task switching area. The user command may be, for example, a tap by a finger or a stylus on the area of the second application window, if a touch screen display is used, or a click by a mouse or other pointing means on the area of the second application window, if a conventional display without a touch input feature is used.

At block 402, in response to opening said second application window, the application windows are rearranged on a display such that the second application window is displayed on a majority part of the display. The majority part of the display may be determined according to a native resolution and aspect ratio of the second application window. Accordingly, by opening the second application window, the second application window now becomes the currently active window, and its size is expanded to cover a majority part of the display.

At block 404, at least the first application window is displayed on the part of the display area available for application windows not covered by the second application window. Thus, the task switching area may not be shown any more on the display, but the display area is covered by the first and the second application window, which is preferable especially with small-sized displays.

“Rearranging” means any actions used to adjust the first application window to cover the area of the display, which is not covered by the second application window. Thus, “rearranging” includes, but is not limited to, reducing or enlarging the size of the first application window e.g. in one or two dimensions, moving the location of the first application window on the display, or a combination of these.

The rearranging of at least the first application window is advantageously performed in response to opening the second application window, e.g. automatically after bringing the second application window on the display. Therefore, in accordance with this embodiment, it is ensured that if there are at least two opened application windows, then at least a first and a second application window are displayed on the display. This facilitates multitasking between the first and the second application window, because both windows are immediately visible on the display. Thus, the user of the data processing device may switch from the first application window to the second application window in a fast and intuitive way.

According to an embodiment, the first and second application windows are the last two application windows activated on the display. Consequently, the currently active (i.e. the second) application window occupies a majority of the display and the last used (penultimate; in this case the first) application window is shown on a smaller part of the display. Accordingly, the user of the data processing device may switch between the two last used application windows with ease.

According to an embodiment, if a user command is then detected for activating the first application window, which is now displayed on the (smaller) part of the display area available for application windows not covered by the second application window, the rearranging of at least the first and the second application windows is carried out by moving a boundary between adjacent borders of the second application window and the first application window along a horizontal or a vertical axis of the display such that the first application window is displayed on a majority part of the display. Thus, the first and the second application windows may be arranged on the display such that the application windows do not overlap each other, but the application windows are parallel, either in horizontal or vertical direction, such that a border of the first application window is adjacent to a border of the second application window. Then, upon detecting a user command for activating said first application window, the data processing device automatically rearranges the application windows by moving a boundary between said borders along a horizontal or a vertical axis of the display. In this embodiment, the application windows remain on their initial locations on the display, e.g. the first application window on the left side of the display and the second application window on the right side of the display, and the size of the application windows is adjusted by moving the boundary between the adjacent borders of said application windows.

According to another embodiment, when a user command is detected for activating the first application window, which is displayed on the (smaller) part of the display area available for application windows not covered by the second application window, the rearranging of at least the first and the second application windows is carried out by arranging the first application window in a desired location on the display and arranging at least the second application window to be displayed on a leftover region of the display. Thus, in this embodiment the most recently activated (i.e. the first) application window may have a default location, e.g. always on the left side of the display, and if initially located on the right side of the display, the most recently activated (i.e. the first) application window is moved to the default location and expanded to cover a majority part of the display.

In this embodiment, it is also possible that the user wants to move the most recently activated (i.e. the first) application window to a desired location on the display e.g. by dragging the window in the middle of display, thus leaving two leftover regions on the display (i.e. on the left side and on the right side of the activated window), whereupon at least the second application window is displayed on either of these leftover regions. It is apparent that said desired/default location may be on the left side of the display, on the right side of the display, on top of the display, on bottom of the display, or in various locations in the middle of the display. Depending on the application and/or user settings, at least in hand-held devices the application windows may be brought to the display either in horizontal or vertical orientation.

FIGS. 5a and 5b illustrate the display views created according to the embodiment, wherein at least the first and the second application windows are rearranged by moving the boundary between the adjacent borders of the second application window and the first application window along the horizontal or the vertical axis of the display.

In FIG. 5a, there is depicted a touch screen display 500 having a first application window 502 activated on the right side of the display 500. The first application window 502 is preferably arranged to cover a majority part of the display according to its native resolution and aspect ratio. A second application window 504 is arranged to cover the remaining part of the available display area on the left side of the display 500. In FIG. 5a, the first and the second application windows 502, 504 are arranged on the display parallel in horizontal direction, such that a border 506 of the first application window 502 is adjacent to a border 508 of the second application window 504.

In FIG. 5a, a user presses the area of the second application window 504 at point 510 by his/her finger to activate the second application window. The processing circuitry 102 detects the activation of the second application window 504 by the touch of the user. Upon detecting the user command for activating the second application window 504, the processing circuitry 102 rearranges the display view by controlling the size of the second application window 504 to expand preferably to its native resolution and aspect ratio. At the same time, the processing circuitry 102 controls the size of the first application window 502 to decrease to cover the remaining part of display area available for application windows. Especially, if the changes in the size of the application windows are carried out smoothly, the expression seen on the display is that the boundary between said borders of the application windows is moved along a horizontal axis of the display.

This is illustrated in FIG. 5b, wherein the size of the second application window 504 has been expanded to its native resolution and aspect ratio, and the size of the first application window 502 has been decreased to cover the remaining part of display area available for application windows. The arrow 512 represents the movement of the boundary between said borders of the application windows.

In this embodiment, the application windows remain on their initial locations on the display, e.g. the first application window on the left side of the display and the second application window on the right side of the display, and only the size of the application windows is adjusted by moving the boundary between the adjacent borders of said application windows.

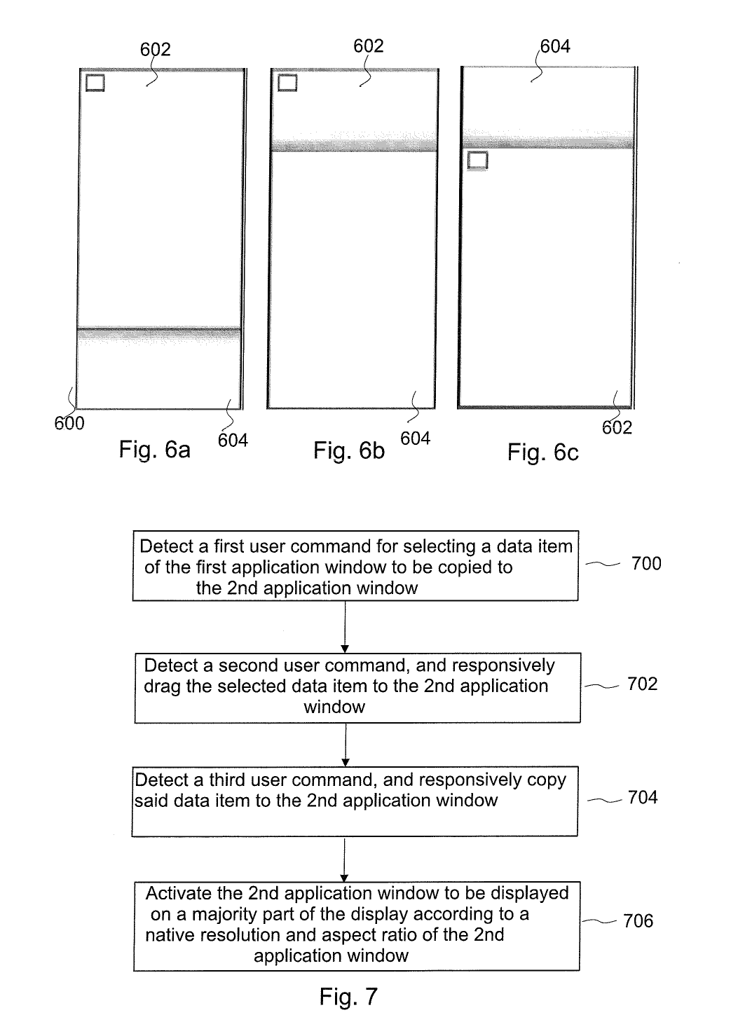

FIGS. 6a, 6b and 6c illustrate some display views for applications, wherein the display is preferable to be used in upright (vertical) position. For example, an image viewer application may be preferable to be used in vertical position. On the other hand, the user may prefer to view any application in vertical position, and thus the apparatus may include a user setting for adjusting the display view either in horizontal or vertical orientation.

In FIG. 6a, the most recently activated application window 602 is arranged to cover a majority part on top of display 600. A second application window 604 is arranged to cover the remaining part of the available display area on bottom of the display 600.

In FIG. 6b, the most recently activated application window 602 is arranged to cover only a minority part on top of display 600, and then the second application window 604 is arranged to cover the remaining (majority) part of the available display area on bottom of the display 600. The display view arrangement of FIG. 6b may be useful in applications providing at least two levels of hierarchy. For example, in a messaging application the upper part (application window 602) may be a list of messages, and the lower part (application window 604) may show the content of one message always on a larger view. In a messaging application, this may provide enhanced usability and natural visibility for both levels of hierarchy.

In FIG. 6c, the most recently activated application window 602 is arranged to cover a majority part on bottom of display 600. A second application window 604 is arranged to cover the remaining part of the available display area on top of the display 600.

It is apparent that similar display views may be arranged for applications, wherein the display is preferable to be used in horizontal position.

FIG. 7 illustrates a flow diagram of a method according to an embodiment, wherein a data item is copied from a first application window to a second application window.

At block 700, a first user command for selecting a data item of the first application window to be copied to the second application window is detected in the data processing device. The data item may be any selectable piece of data, such as a file, a character string, a hyperlink, an embedded graphics, etc. The user selects the data item, for example, by tapping or painting the data item by a finger or a stylus, if a touch screen display is used, or a clicking/painting the data item by a mouse or other pointing means. The means for selecting data items is dependent on the technical implementation of the data processing device, but in any case the processing circuitry 102 detects the selection of the data item by the user.

At block 702, in response to detecting a second user command, the selected data item is dragged to said second application window. Herein, the second user command typically relates to the operation by the user, where the user actively keeps the data item selected and starts to move the selected data item along the display screen's surface. This may be performed by, for example, tapping the data item by a finger or a stylus and holding down the tap (“tap-and-hold”), i.e. not lifting the finger or the stylus off the screen, in the case where a touch screen display is used. The processing circuitry 102 may detect this part of the second user command (“tap-and-hold”), for example, on the basis of the duration of the tap, or from the lack of lift-off of the finger or the stylus from the screen. Alternatively, the similar effect can be achieved, for example, by a mouse button command “click-and-hold”.

As a further part of the second user command, the user drags the selected data item to the second application window along the display screen's surface. On the basis of the detection of the first part of the second user command (“tap-and-hold”/“click-and-hold”), the processing circuitry 102 is configured to detect the movement of the selected data item to the second application window.

At block 704, in response to detecting a third user command, said data item is copied to said second application window. Herein, the third user command typically relates to the operation by the user, where the user stops the second user command, e.g. by lifting off the finger or the stylus from the screen or by releasing the mouse button. Upon detecting said third user command, the processing circuitry 102 retrieves the selected data item from the storage device 104 and controls the selected data item to be copied to the second application window.

At block 706, said second application window is activated to be displayed on a majority part of the display according to a native resolution and aspect ratio of the first application window. Accordingly, the processing circuitry 102 controls the touch screen display device to display the second application window as the currently active window, and its size is expanded to cover a majority part of the display.

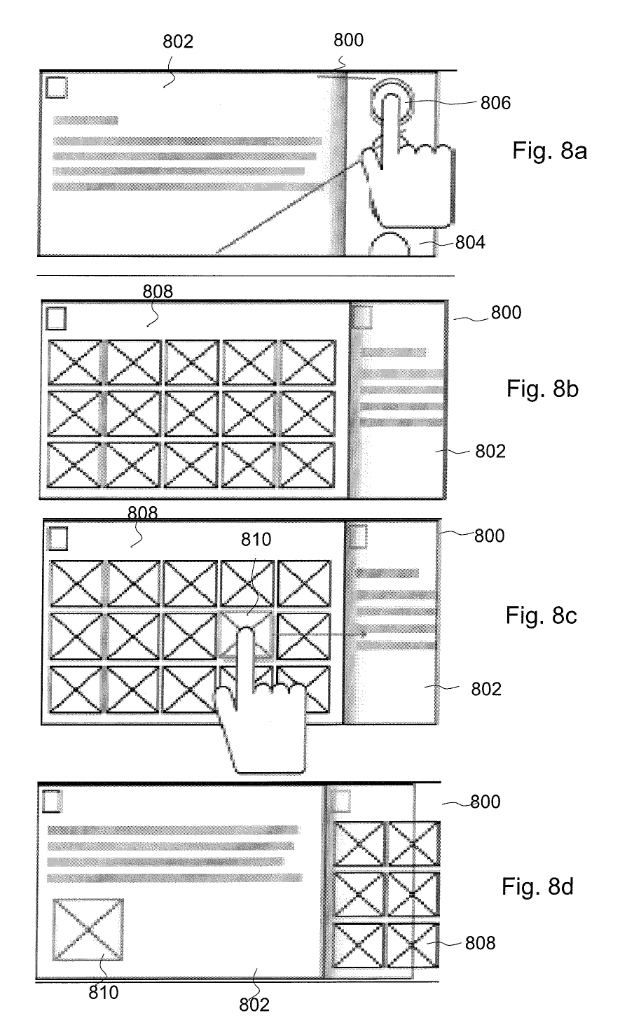

FIGS. 8a, 8b, 8c and 8d illustrate, by means of exemplary display views, the performance of the method according to the embodiment of FIG. 7. In FIG. 8a, there is depicted a touch screen display 800 having only a first application window 802 activated. The first application window 802 is preferably arranged to cover a majority part of the display according to its native resolution and aspect ratio, and a task switching area 804 including several user interface elements representing activation buttons for an application window or an underlying application is arranged to cover the remaining part of the display. The user interface elements may also relate to different applications or to opened, but deactivated application windows. In FIG. 8a, a user presses the user interface element 806 by his/her finger to activate a second application window. The processing circuitry 102 detects the activation of the second application window by the touch of the user.

In FIG. 8b, the second application window 808 has been activated on the left side of the touch screen display 800, preferably arranged to cover a majority part of the display according to its native resolution and aspect ratio. The first application window 802 is now modified to be displayed on the remaining part of the display area available for application windows, i.e. on the right side of the touch screen display 800. Herein, the processing circuitry 102 retrieves a predetermined setting for the display view (“currently activated application window on the left side of the display”) from the storage device 104 and arranges the first and the second application window accordingly.

In FIG. 8c, the user selects a data item 810 from the second application window 808 by tapping the data item 810 with his/her finger and holding down the tap, and then the user starts to drag the selected data item 810 to the second application window 802 along the display screen's surface. The processing circuitry 102 is configured to detect both the “tap-and-hold” user command, and in response to that, also the movement of the selected data item to the first application window 802.

When the data item 810 has been dragged to the second application window 802, the user lifts off his/her finger or otherwise releases the “tap-and-hold” user command. Upon detecting this release command to take place on the area of the first application window 802, the processing circuitry 102 retrieves the selected data item 810 from the storage device 104 and controls the data item 810 to be copied to the first application window 802. Furthermore, copying the data item 810 to the first application window 802 makes the first application window 802 again the currently activated application window, whereupon the processing circuitry 102 rearranges the first and the second application window according to said predetermined setting for the display view.

The result of this procedure is shown in FIG. 8d, wherein the currently activated application window, i.e. the first application window 802 is arranged on the left side of the display 800, preferably according to its native resolution and aspect ratio, including the copied data item 810. The second application window 808 is, in turn, modified to be displayed on the remaining part of the display area available for application windows, i.e. on the right side of the touch screen display 800, as explained above. Accordingly, in this example the display view is rearranged by arranging the first application window in a desired location on the display and arranging the second application window to be displayed on a leftover region of the display. In other words, in this example the display view is not rearranged by moving the boundary between the application windows.

According to an embodiment, the apparatus may be arranged to modify, in response to activating the first application, at least two application windows to be displayed on the remaining part of the display area available for application windows. Thus, instead of displaying two (last activated) application windows on the display, there may be a plurality (altogether 3, 4, 5, etc.) of application windows shown on the display.

Again, the currently activated application window is displayed on a (majority) part of the display, but the remaining part of the display area available for application windows is shared between two or more application windows. This facilitates the multitasking in situations where a plurality of application windows should be edited or used as a source of data items at the same time.

The number of application windows arranged on the display may depend on the size of the display. Particularly, in portable devices having a small-sized touch screen display the usability may suffer, if there are too many application windows arranged on said remaining part of the display area available for application windows.

Thus, according to an embodiment, the application windows to be displayed on the remaining part of the display are modified such that the size of said application windows is at least a predetermined minimum size enabling effortless touching of said application windows. Accordingly, there is a predetermined minimum size for the windows arranged on said remaining part of the display area, which minimum size is large enough to be easily touched e.g. by a finger. Depending on the size of the whole display and the (majority) area covered by the currently activated application window, the processing circuitry 102 is configured to limit the number of simultaneous application windows sharing the remaining part of the display area available for application windows such that the number of said simultaneous application windows multiplied by the predetermined minimum size may not exceed the size of said remaining part of the display area available for application windows.

A skilled man appreciates that any of the embodiments described above may be implemented as a combination with one or more of the other embodiments, unless there is explicitly or implicitly stated that certain embodiments are only alternatives to each other.

The invention may provide advantages through the ease of multitasking, which is achieved by displaying at least two application windows on the display. For example, a copy-paste operation between two last used application windows becomes fast and intuitive. According to an example embodiment, the native resolution and aspect ratio of an application window is smaller than size of the display, whereby the leftover area of the display is advantageously reserved for another application window. The invention may especially enhance multitasking when used in handheld apparatuses including a touch screen. For example, bringing the currently activated application window automatically to cover a major part of the display by a simple tap, and still arranging the previously used application window on the remaining part of the display facilitates multitasking between the application windows significantly. Generally, the different embodiments may simplify the use of applications on a platform where the invention is applied.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
controlling a data processing device to display a first application on a display area;
determining a size of a displayed first application area; and
controlling, in response to determining that the size of the display area is larger than the displayed first application area, the data processing device to display a task switching area on the remaining part of the display area.

2. The method according to claim 1, wherein
said task switching area provides one or more user interface elements for accessing other applications or application windows of the data processing device.

3. The method according to claim 1, further comprising:
activating said first application area to be displayed on a majority part of the display area according to a native resolution and aspect ratio of the first application area; and
controlling, in response to detecting that the native resolution and aspect ratio of the first application area is smaller than the size of the display area of the data processing device, the data processing device to open the task switching area to be displayed on the remaining part of the display area.

4. The method according to claim 1, further comprising:
activating said first application area to be displayed on the part of the display according to a user command; and
controlling, in response to detecting that the first application area is arranged to be displayed on a display size smaller than the size of the display area of the data processing device, the data processing device to open the task switching area to be displayed on the remaining part of the display area.

5. The method according to claim 1, further comprising:
detecting a user command for opening a second application area, said user command being provided via a user interface element in said task switching area;
in response to opening said second application area, rearranging the application areas on a display such that the second application area is displayed on a majority part of the display; and
at least the first application area is displayed on the part of the display area available for applications not covered by the second application area.

6. The method according to claim 5, further comprising:
detecting a user command for activating the first application area displayed on the part of the display area available for applications not covered by the second application area; and
rearranging at least the first and the second application areas by moving a boundary between adjacent borders of the second application area and the first application area along a horizontal or a vertical axis of the display such that the first application area is displayed on a majority part of the display.

7. The method according to claim 5, further comprising:
detecting a user command for activating the first application area displayed on the part of the display area available for application not covered by the second application area; and
rearranging at least the first and the second application areas by arranging the first application area in a desired location on the display and arranging at least the second application area to be displayed on a leftover region of the display.

8. The method according to claim 5, further comprising:
detecting a first user command for selecting a data item of the first application area to be copied to the second application area;
dragging, in response to detecting a second user command, the selected data item to said second application area;
copying, in response to detecting a third user command, said data item to said second application area; and
activating said second application area to be displayed on a majority part of the display according to a native resolution and aspect ratio of the second application area.

9. The method according to claim 1, wherein the first and the second application areas are application windows of different applications, or the first and the second application windows are two different application windows of a particular application.

10. An apparatus comprising at least one processor and at least one memory storing computer program code, wherein the at least one memory and the computer program code being configured to, with the at least one processor, cause the apparatus to at least:
control a first application to be displayed on a display area;
determine a size of a displayed first application area; and
control, in response to determining that the size of the display area is larger than the displayed first application area, the apparatus to display a task switching area on the remaining part of the display area.

11. The apparatus according to claim 10, wherein said task switching area provides one or more user interface elements for accessing other applications or application windows of the data processing device.

12. The apparatus according to claim 10, wherein the at least one memory and the computer program code being configured to, with the at least one processor, cause the apparatus to:
activate said first application area to be displayed on a majority part of the display according to a native resolution and aspect ratio of the first application area; and
control, in response to detecting that the native resolution and aspect ratio of the first application area is smaller than the size of the display of the data processing device, the apparatus to open the task switching area to be displayed on the remaining part of the display area.

13. The apparatus according to claim 10, wherein the at least one memory and the computer program code being configured to, with the at least one processor, cause the apparatus to:
activate said first application area to be displayed on the part of the display according to a user command; and
control, in response to detecting that the first application area is arranged to be displayed on a display size smaller than the size of the display of the data processing device, the apparatus to open the task switching area to be displayed on the remaining part of the display area.

14. The apparatus according to claim 10, wherein the at least one memory and the computer program code being configured to, with the at least one processor, cause the apparatus to:
detect a user command for opening a second application area, said user command being provided via a user interface element in said task switching area;
rearrange, in response to opening said second application area, the application areas on a display such that the second application area is displayed on a majority part of the display; and
display at least the first application area on the part of the display area available for applications not covered by the second application area.

15. The apparatus according to claim 14, wherein the at least one memory and the computer program code being configured to, with the at least one processor, cause the apparatus to:
detect a user command for activating the first application area displayed on the part of the display area available for applications not covered by the second application area; and
rearrange at least the first and the second application areas by moving a boundary between adjacent borders of the second application area and the first application area along a horizontal or a vertical axis of the display such that the first application area is displayed on a majority part of the display.

16. The apparatus according to claim 14, wherein the at least one memory and the computer program code being configured to, with the at least one processor, cause the apparatus to:
detect a user command for activating the first application area displayed on the part of the display area available for applications not covered by the second application area; and
rearranging at least the first and the second application areas by arranging the first application area in a desired location on the display and arranging at least the second application area to be displayed on a leftover region of the display.

17. The apparatus according to claim 14, wherein the at least one memory and the computer program code being configured to, with the at least one processor, cause the apparatus to:
detect a first user command for selecting a data item of the first application area to be copied to the second application area;
detect a second user command, and responsively drag the selected data item to said second application area;
detect a third user command, and responsively copy said data item to said second application area; and
activate said second application area to be displayed on a majority part of the display according to a native resolution and aspect ratio of the second application area.

18. The apparatus according to claim 10, wherein the at least one memory and the computer program code being configured to, with the at least one processor, cause the apparatus to:
control, in response to activating the first application area on said part of the display, at least two application areas to be displayed on the remaining part of the display area.

19. The apparatus according to claim 10, wherein said display is a touch screen display and the activation is carried out by touching the application area in question or the user interface element representing said application area or underlying application in said task switching area, wherein the at least one memory and the computer program code being configured to, with the at least one processor, cause the apparatus to:
modify at least a second application area to be displayed on the remaining part of the display such that the size of the at least second application area is at least a predetermined minimum size enabling effortless touching of the at least second application area.

20. A computer-readable storage medium comprising computer program code, which computer program code, when executed in at least one processor, is configured to cause an apparatus to at least:
control a first application to be displayed on a display area;
determine a size of a displayed first application area; and
control, in response to determining that the size of the display area is larger than the displayed first application area, the apparatus to display a task switching area on the remaining part of the display area.
